(19) United States
(12) Patent Application Publication
(10) Pub. No.: US 2009/0286201 A1
(43) Pub. Date: Nov. 19, 2009

(54) Dental implant drill apparatus and method

(76) Inventor: Mike Wansik Choe, Fayetteville, NC (US)

Correspondence Address: OLIVE & OLIVE, P.A., 500 MEMORIAL STREET, PO BOX 2049, DURHAM, NC, 27702, US

(21) Appl. No.: 12/152,899

(22) Filed: May 16, 2008

(51) Int. Cl. A61C 3/02; A61C 3/04

(52) U.S. Cl. 433/165; 433/75

(57) ABSTRACT

A device is operatively associated with a drill used in connection with forming a hole in which a dental implant is to be installed. The device is made in multiple sizes suitable for accommodating differences in spacing between existing teeth between which one or more new prosthetic teeth are to be installed as well as accommodating differences in the bucco-lingual alveolar ridge width and the mesio-distal alveolar ridge length between the existing teeth where the implant is to be installed. The device is formed in such a way as to aid correct placement of the dental drill during implant surgery. The device permits the size of the proposed implant to be evaluated by visual comparison with the size of the selected implant site. The device further permits locating the dental implant pilot drill correctly so as to achieve successful implant placement.

### BACKGROUND OF THE INVENTION

1. Field of the Invention

The present invention relates to apparatus and methods for properly positioning a drill during dental implant surgery.

2. Description of Related Art

Replacement of missing natural teeth with teeth of similar shape and size fills an important need for those who have lost one or more of their teeth for one reason or another. A conventional practice for installing a prosthetic tooth involves drilling an initial vertical pilot hole in the jawbone of the patient followed in some instances after inspection of the initial pilot hole by drilling a larger pilot hole and in other instances by drilling a large vertical hole substantially concentric with the pilot hole and which is sized to receive the implant to which the prosthetic tooth will be attached. While implant surgery of the kind being referred to provides for replacement of multiple teeth as well as a single tooth, the replacement of a single tooth between two existing teeth will be primarily used for reference when describing the device of the present invention and when comparing the device of the present invention with those found in the prior art.

Desirably, the drill bit itself is not allowed to wobble or tilt abnormally, particularly when drilling a pilot hole for implant surgery. Rather, it is desired that the drill bit and its drive mechanism be held very steadily and in such a way that the axis of the drill bit itself throughout drilling of the pilot hole substantially coincides with a substantially fixed vertical axis that is parallel to the vertical axes of the teeth adjoining the tooth being replaced. So far as applicant is aware, none of the dental implant pilot hole drill guides of the prior art attaches to the pilot drill or provides a means for creating a simulation of the angular relation between these axes.

It is also recognized that dental implant pilot drill positioning devices of the prior art are deficient in their ability to accommodate a wide range of different widths of jawbone in which to mount an implant as well as a wide range of widths of spaces between existing teeth between which a new tooth is being implanted. Such devices of the prior art also lack means for judging the vertical and horizontal relationship of the drill bit to the boney ridge.

The mentioned as well as other deficiencies in the prior art practices are thus sought to be overcome.

### BRIEF SUMMARY OF THE INVENTION

The invention is an aid for properly positioning a dental drill bit while drilling a pilot hole in a patient's alveolar ridge, or jawbone, as part of installing a dental implant in a patient. More specifically, the invention consists of a drill assembly that provides a somewhat tooth-shaped object, associated with a drill bit, whose location relative to existing teeth can aid the dentist in properly positioning the drill bit. These existing teeth may be immediately adjacent to the location of the missing tooth being replaced, or more distant, as when installing multiple adjacent implants. The drill bit assembly of the invention has in appearance that of an inverted substantially frustum-shaped upper tapered portion. The upper tapered portion of the device is not necessarily a true frustum. The invention recognizes with respect to the upper portion a top surface that is flat, a top surface that is slightly conical, and in a preferred embodiment a top surface that is slightly outwardly curved. These variations are meant to be included in the term “substantially frustum-shaped.” In connection with the substantially frustum-shaped device of the invention, the term “inverted” is intended to mean that when in use the bottom surface of the frustum is of a smaller diameter than that of the top surface. The diameter at the bottom of the substantially frustum-shaped upper portion of the device corresponds to the diameter of the proposed implant. This upper tapered portion is what is referred to as “the drill bit mount device” or simply as the “device”. The upper tapered portion is optionally accompanied by an optional lower cylindrically shaped portion whose diameter also corresponds to the diameter of the proposed implant. In such cases the term “drill bit mount device” includes that accompanying lower portion. The device can be made, by way of example, of a metal, a ceramic, a polymer or a composite. A drill bit-receiving central hole is formed along a central vertical axis in the drill bit mount device for receiving a drill bit. The drill bit mount device is attached to the drill bit by fastening means, such as a screw, pin, wedge, key, adhesive or by friction. These terms are intended broadly. For example, a wedge could be a flexible torus-shaped device such as one or more O-rings wedged between the outer surface of the drill bit and the inner surface of the central hole in the drill bit mount device. While use of O-rings for fixedly mounting objects on rotating shafts is generally known to those skilled in the mechanical arts it has not been known, so far as applicant is aware, to use O-rings this way in the type device being described. In another arrangement, the fastener is a setscrew extending to the drill bit through a setscrew hole in the “device” and into the bit-receiving central hole. Another arrangement for attaching the drill bit mount device to the drill bit is to make the clearance between the central hole in the device and the outer drill bit surface tight enough so that the device is held in place by friction.

The substantially uniformly tapered inverted and substantially frustum-shaped upper tapered portion of the device is oriented with the small end of the taper toward the tip of the drill bit. The upper tapered portion of the device, optionally accompanied by the optional non-tapered cylindrical lower portion of the device, supplies, prior to any drilling, as later explained, a means for comparing the diameter of the proposed implant to the bucco-lingual alveolar ridge width and the mesio-distal alveolar ridge length between the existing teeth where the implant is to be installed. This comparison can be done in two ways. When the substantially frustum-shaped upper tapered portion is not accompanied by the optional lower portion, the frustum-shaped upper tapered portion terminates at the bottom with a diameter suitable for comparing the diameter of the proposed implant to the bucco-lingual alveolar ridge width and the mesio-distal alveolar ridge length between the existing teeth, without the presence of the non-tapered cylindrical lower portion. However when the upper and lower portions are both present, the uniform diameter of the lower cylindrical shaped portion provides a means for making this comparison.

The central hole in the center of the device, in which the drill bit is normally mounted, may be fitted with one or more O-rings that grasp the shaft of the drill bit and hold it in an adjustable position suited to the depth of drilling desired. This means for fastening can thus be considered as an example of the wedge mentioned previously.

In another arrangement of the invention as previously referred to, the portion(s) of the drill bit mount device are formed integral with the drill bit and the drill bit is not adjustable with respect to the drill bit mount device. That is, the drill bit and the drill bit mount device of the arrangement are formed as a single structure and in various sizes and lengths to accommodate different spacing between existing teeth, different widths of the bucco-lingual ridge, different mesio-distal ridge lengths between existing teeth and different depths of drilling during the implant procedure.

The drill bit mount device of the invention in each of its arrangements is made in various sizes. A particular size is proposed according to the size of the drill, the width of jawbone available for drilling and the amount of space between the existing teeth between which the implant is to be mounted. A drill bit mount device is selected whose diameter at the bottom (of its upper portion if only the upper portion is present, or of its lower portion if the upper portion is accompanied by a lower portion) corresponds to an implant size believed to be suited to the width of jawbone available in a particular patient. The drill employed in the mentioned arrangements is initially positioned so that the bottom end of the drill bit is flush with the bottom surface of the device. When portions of the drill bit mount device are made integral with the drill bit as in a previously mentioned other arrangement, one of the drill bit mount devices is made with a flat bottom surface to facilitate comparing the diameter of the lower portion of the drill bit mount device with the bucco-lingual width of the ridge and the mesio-distal length of the ridge available. The taper in the upper portion of the device, provided by its substantially frustum shape as described above, permits the dentist to place the device of selected size between the pair of existing teeth, tilt the device, and observe the diameter of the bottom of the device so as to be able to compare the diameter of the proposed size of implant with the width of the bucco-lingual ridge and the length of the mesio-distal portion of the ridge between the existing teeth at that point before the drilling begins. If the diameter of the bottom surface of the device is wider than the available space of bone in the area in which the implant is intended to be mounted, a smaller size device of the invention is selected.

A visible dot or mark may be formed on the outer periphery of the top of the upper portion of the device. During drilling, that mark spins, and when the drill bit is properly positioned the spinning mark defines a circle visible to the eye of the dentist in a plane parallel to the apparent plane of nearby existing teeth's upper surfaces. These nearby teeth might be two teeth adjacent to where the implant is intended to be installed. The dentist positions the drill bit so as to align the plane of the circle with the plane formed by the top surfaces of the patient's existing teeth. Thus, the dentist performing the implant operation is able to effectively “see” and sense both whether the drill bit is properly positioned with reference to the jawbone in which the implant is to be mounted and whether the drill bit is properly aligned with respect to existing teeth near the implant site.

The drilling is facilitated by use of cooling fluid, such as sterile isotonic water solution, admitted to the site of drilling. Its flow is dispersed by the presence of grooves formed in the top and side surfaces of the upper portion of the device. In one arrangement, a first set of top-surface grooves aligned with each other and extending across the top surface of the upper portion of the device are in perpendicular relation to and intersect a second set of top-surface grooves aligned with each other. Side-surface grooves are formed in the side surface of the upper portion such that any cooling fluid, typically water, admitted to any of the first and second set of top-surface grooves is encouraged to flow through the side-surface grooves. The top-surface grooves also perform the function of aiding alignment of the drill bit mount device with nearby teeth. The drill bit can be positioned so that one of the grooves is lined up with the nearby existing teeth.

A form of the drill bit mount device of the invention useful for forming a dental implant pilot hole of predetermined depth and diameter employs an inverted, substantially frustum-shaped, upper portion extending downwardly from a top surface whose bottom diameter is at least 2 mm smaller than its top diameter and whose height is less than 2 cm.

In another arrangement of the device of the invention, the top of the drill bit above the upper portion of the device is removed which enables the remaining lower portion of the drill bit protruding from the bottom to be inserted into the pilot hole in the patient's jaw as a guide pin for X-ray evaluation of the pilot hole position and further enables the upper portion of the device to serve as a model of the spatial relationship between the existing teeth and the crown to be installed using the pilot hole as drilled.

Further advantage is achieved by use of a cutting tool on the bottom of the upper portion of the device of the invention to facilitate cutting and leveling the surface of the alveolar ridge and any tissue between the ridge and the cutting surface.

In a further arrangement, a rod is attached to the top of the lower cylindrical portion of the device, thereby providing a measuring tool for visually measuring the availability of adequate space for installing a selected implant of similar diameter to that of the lower cylindrical portion. The substantially frustum-shaped upper portion of the device of the invention can be added by slipping the rod through the central hole of the device to provide a measuring tool that will show the relationship between the crown (artificial tooth) to be installed and the existing teeth.

### BRIEF DESCRIPTION OF THE SEVERAL VIEWS OF THE DRAWINGS

FIG. 1 is a somewhat schematic elevation view of a pair of existing spaced-apart teeth between which a crown (artificial matching tooth) is to be mounted by means of the device of the invention.

FIG. 2 is a perspective view of one arrangement of the drill bit mount device of the invention apart from the patient and illustrating the vertical drill-mounting central hole in which the drill bit is mounted as well as the setscrew hole, but without an associated drill bit or setscrew.

FIG. 3 is a plan view of the device shown in FIG. 2.

FIG. 4 is an elevation view taken in the direction of line 4-4 of FIG. 3, showing the dome-like shape of the top of the device.

FIG. 5 is an elevation section view taken in the direction of line 5-5 of FIG. 4 but with the setscrew removed.

FIG. 6 is an elevation view of the device in an arrangement similar to that of FIG. 4 but with the drill bit shown mounted in a selected position by means of a setscrew and without its power head.

FIG. 7 is a section view illustrating an arrangement of the drill bit mount device in which one or more O-rings are snugly fitted in the central hole in which the drill bit is mounted to make the drill bit position slidably adjustable.

FIG. 8 is a section view illustrating a form of construction of the drill bit mount device in which the drill bit, only partially illustrated, and drill bit mount device are molded, cast, machined or otherwise formed as an integral structure.

With regard to FIG. 9, recall that the device of the invention is made in several sizes to accommodate various drill sizes, varying widths of the bucco-lingual ridge and varying lengths of the mesio-distal portion of the ridge between the existing teeth, and that the size diameter of the bottom of each drill bit mount device corresponds to a particular implant size. FIG. 9 schematically illustrates, using one of the devices of FIG. 2 by way of example, how the dentist is able roughly visually to compare the width of the patient's bucco-lingual ridge (not shown) and length of the mesio-distal portion of the ridge between the existing teeth with the diameter of the bottom of the drill bit mount device. The comparison is accomplished by tilting the device with the drill bit withdrawn from its drilling position so as to allow the bottom surface of the lower portion of the device of the invention to approach the bucco-lingual ridge (not shown).

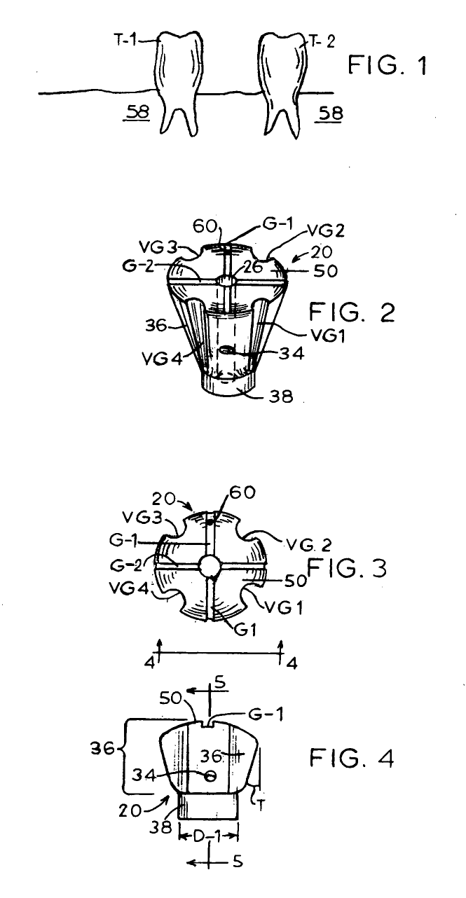

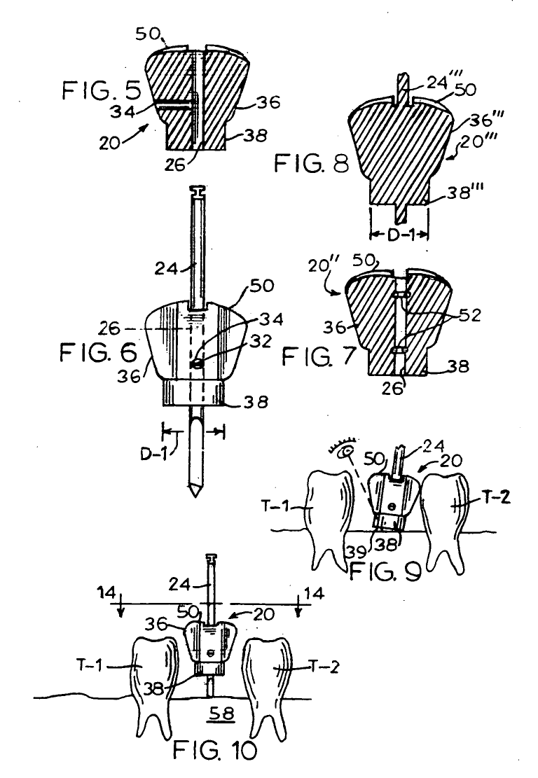

FIG. 10 illustrates the drill bit mount device and drill bit assembly of FIG. 6 located in a starting position between the spaced apart existing teeth of FIG. 1, the drill power head not being shown.

FIG. 11 illustrates the drill bit mount device and drill bit assembly of FIG. 10 after having drilled an initial depth into the bone.

FIG. 12 illustrates the device of the invention being used to evaluate the depth and the mesio-distal angulation of the initial pilot hole using X-rays.

FIG. 13 shows the existing teeth and pilot hole of FIG. 12 without the device in order to better illustrate the pilot hole.

FIG. 14 illustrates, in reduced size for convenience, a view taken generally in the direction of line 14-14 of FIG. 10, the drill's power head not being shown. FIG. 14 illustrates a circle C visible to the eye of the dentist created by the rotating visible dot 60 (FIGS. 2, 3). The rotating dot appears to the eye of the dentist as being located in the apparent plane P-1 of the upper surfaces of the existing teeth between which an implant is intended to be installed. The plane of the circle indicates proper alignment of the drill bit with respect to the plane in which the top surfaces of the existing teeth are located. One pair of top-surface grooves G-2 lines up with the midline (dotted line) of nearby teeth T-1 and T-2 to aid in correct alignment of the drill bit mount device.

FIG. 15 illustrates somewhat schematically and in an elevation view an imaginary plane P visualized by the dentist during drilling, whose level coincides with the level of the top surfaces of the existing teeth, so as to indicate proper alignment of the drill bit with respect to the existing teeth.

FIG. 16 schematically illustrates a final hole drilled to proper depth using the drill bit mount device of the invention in preparation for being followed by one or more larger diameter drill bits and ready to receive an implant.

FIG. 17 schematically illustrates the crown installed between the existing teeth and secured to the implant.

FIG. 18 schematically illustrates a section view such as found in FIG. 5 illustrating a form of the device in which the optional lower cylindrical portion below the upper frustum shaped portion is absent and not used.

FIG. 19 schematically illustrates a modification of the construction of the device as shown in FIG. 6 in which after an upper portion of the drill bit has been cut off, a lower portion of the drill bit is used, for service as a guide pin for X-ray evaluation when inserted into a drilled pilot hole and as providing a way for indicating the expected location and position of the implant and crown before they have actually been installed.

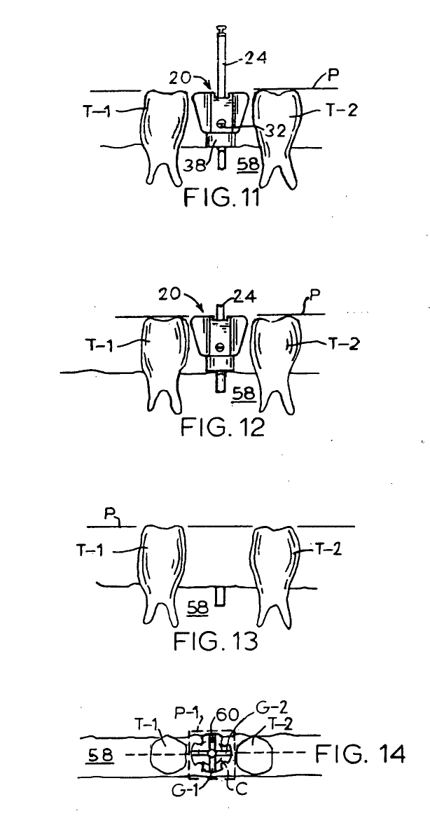

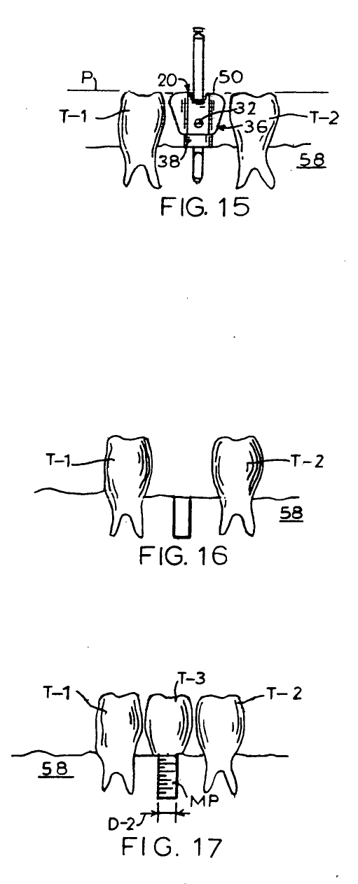

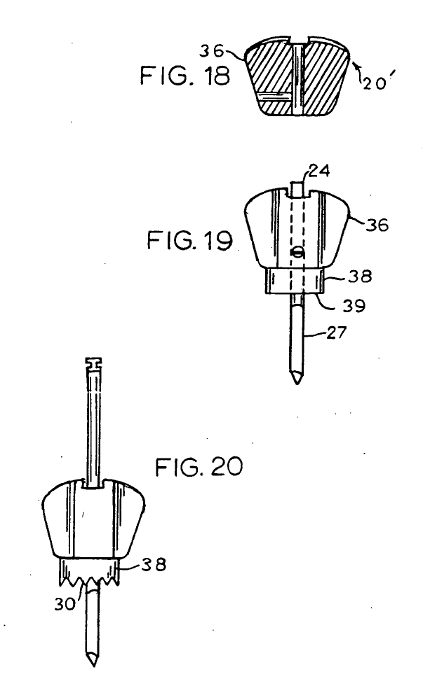

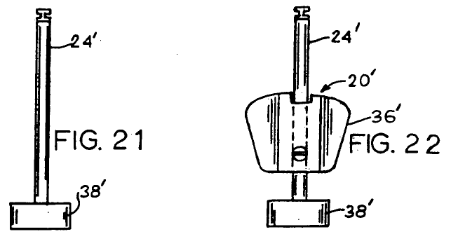

FIG. 20 schematically illustrates in a further construction a modification of the device as shown in FIG. 8 in which the lower cylindrical portion of the device is formed with a cutting surface.

FIG. 21 schematically illustrates how the lower cylindrical portion of the device may be attached to a rod, so as to provide a measuring tool for visually measuring the availability of adequate space for installing a selected implant.

FIG. 22 schematically illustrates the modified frustum-shaped device 20′ of FIG. 18 assembled with the measuring tool of FIG. 21.

### DETAILED DESCRIPTION OF THE INVENTION

Referring initially to the construction of FIG. 6, drill bit 24 is slidably received in central hole 26 (FIG. 5) and is held in a selected position by means of a setscrew 32 (FIG. 6) mounted in a setscrew hole 34 (FIG. 5). Alternatively, the drill bit can be held by other fastening means, such as a screw, pin, wedge, key, adhesive or by friction. Preferably, the central hole passes through the center of mass of the drill bit mount device in order to avoid wobble when the drill bit and mount rotate during drilling. Drill bit 24 is powered by an appropriate power source or drive unit not shown in the drawings.

The dental implant drill bit mount device 20 (FIG. 2) is made in various sizes and constructions. A particular size is proposed according to the size of drill, the width of jawbone 58 (FIG. 1) available for implant insertion and the amount of space between the existing teeth T-1 and T-2 (FIG. 1) between which the implant MP (FIG. 17) is to be placed. The bottom diameter D-1 (FIG. 4) of the device approximates the diameter D-2 of the proposed implant MP (FIG. 17) suited to the available dimensions of jawbone 58. This permits the dentist to evaluate the appropriateness of the chosen implant diameter by means of the drill bit mount device before the hole is actually drilled. The width of the inverted substantially frustum-shaped upper portion 36 of the drill bit mount device 20 is somewhat smaller than the proposed crown to be inserted. The upper portion 36 of the device 20 is described as being “substantially frustum-shaped” because of top surface 50 being of a somewhat dome shape instead of being flat consistent with the definition of “frustum”. The smaller size and the taper T (FIG. 4) of the tapered portion 36 of the inverted substantially frustum-shaped drill bit mount device permits the dentist to compare the spatial relationship between the existing teeth and the proposed crown to be inserted. If the bottom surface 39 (FIG. 9) of the bottom of the drill bit mount device 20 is wider than the available width of jawbone 58 (FIG. 1) in which the implant MP (FIG. 17) is intended to be mounted, a smaller size drill bit mount device is selected.

As previously mentioned, drilling is facilitated by use of a cooling fluid, typically water, supplied to the site of drilling. Its flow is dispersed by the presence of grooves formed in the top surface 50 of the tapered portion 36 of the drill bit mount device 20 (FIG. 2). A first set of top-surface grooves G-1 (FIGS. 2, 3) are aligned with each other, extend across the top surface 50 (FIGS. 3, 4) of the tapered portion 36 of the drill bit mount device 20, and are in substantially perpendicular relation to a second set of top-surface grooves G-2 (FIGS. 2, 3) aligned with each other. Sets of side-surface grooves VG0, VG2, VG3, and VG4 are present on the side of the device and help guide the cooling fluid. The top surface can be flat, somewhat dome-shaped, or somewhat conical. The dome shape, shown in FIG. 4, is preferred.

In addition to aiding the flow of cooling fluid, top-surface grooves G-1 and G-2 (FIGS. 2, 3) can be used to help align the drill bit with respect to existing teeth in the patient's mouth. The drill bit mount device is positioned so that a top-surface groove is in mesio-distal alignment with existing teeth on either side of the planned location of the implant.

A visible dot 60 (FIGS. 2, 3), preferably red, or other visible mark may be formed on the outer periphery of the top surface of the device and during drilling creates a circle C (FIG. 14) visible to the eye of the dentist. When the drill bit is properly positioned, the circle appears to be located in the apparent plane P of the upper surfaces of the existing teeth T-1, T-2 between which the implant MP (FIG. 17) is intended to be installed. Thus, the dentist performing the implant operation is able effectively to “see” and sense whether the drill bit is or is not properly positioned with reference to the jawbone 58 in which the implant MP is to be mounted as well as being properly positioned with respect to the existing teeth T-1, T-2 between which the implant MP is to be mounted.

As previously mentioned, the uniformly inwardly tapered inverted, substantially frustum-shaped drill bit mount device 20 (FIG. 4), has a bottom diameter D-1 that approximates a diameter D-2 (FIG. 17) of the proposed implant. Whether or not accompanied by an optional integral cylindrical lower portion 38 (FIG. 4), also with a bottom diameter D-1, the device 20 provides a means for comparing, as in FIG. 9, the diameter of the proposed implant MP (D-2, FIG. 17) with the width of the bucco-lingual ridge (not shown) and length of the mesio-distal portion of the ridge located in the space between the two existing teeth T-1, T-2 (FIG. 1) between which the implant MP is to be installed. Thus, any such comparison which reveals that the diameter of the bottom of the drill bit mount device 20 is wider than the area of the jawbone 58 (FIG. 1) available for drilling gives cause for not drilling and looking for a device whose bottom is of suitable diameter.

In the construction of the drill bit mount device 20″, illustrated in FIG. 7, the central hole 26 is fitted with one or more O-rings 52 (FIG. 7) in which the shaft of the drill bit 24 can be mounted. The inner diameter of the O-rings is selected to permit a releasable grip on the shaft of drill bit 24 (not shown in FIG. 7). That is, the O-ring size is selected so as to enable the drill bit mount device 20″ to maintain its position during normal drilling but to be capable, under sufficient force, of being slid along the drill bit so as to assume a new position compatible with a new depth of drilling.

In the construction of the invention as previously referred to and as illustrated in FIG. 8, the drill bit mount device 20′″ is formed integral with the drill bit 24′″. In this construction, the setscrew or other fastener is eliminated and the drill bit is not adjustable with respect to the inverted frustum-shaped tapered portion. The drill bit and the drill bit mount of this construction are formed in various sizes and lengths as single integral structures and in various sizes to accommodate different spacing between existing teeth, different widths of the bucco-lingual ridge, different lengths of the mesio-distal portion of the ridge between the existing teeth and different depths of drilling during the implant procedure. As previously mentioned, one of the multiple devices derived from the invention has a substantially flat surface, not shown, on the bottom of the drill bit mount device 20′″ to facilitate measurement of the location for the proposed implant. The drill bit mount device 20′″ is chosen so that its diameter D-1 (FIG. 8) at the bottom approximates the diameter of the proposed implant for comparison of the implant diameter D-2 with area available prior to drilling.

FIG. 18 shows a construction of the drill bit mount device used for forming a dental implant pilot hole of predetermined depth and diameter. Specifically, it shows a modified substantially frustum-shaped device 20′ with a tapered portion 36 extending downwardly from a top surface whose top diameter is larger than its bottom diameter, and where its bottom diameter is substantially the same as the diameter of an implant proposed for being installed in a patient's mouth. The modified substantially frustum-shaped device 20′ has a bottom diameter that is at least 2 mm smaller than its top diameter and has a height of less than 2 cm. Further, it can have at least one top-surface groove (not shown) formed in its top surface, as well as one or more optional side-surface grooves (not shown) on the side. It also has means for accommodating vertically a drill bit in a central location. That means can be a vertical hole centrally located in the drill bit mount device for accepting a drill bit, or there can be a drill bit manufactured integrally with the drill bit mount device. Also included is means, for example setscrews, pins, wedges, keys, adhesive or friction for maintaining the position of the mount on the drill bit. That means can include manufacturing the mount device and the drill bit as a single unit.

FIG. 19 shows a further construction of the device. The upper portion of the drill bit 24 is shortened by cutting above the drill bit mount device. This leaves the tapered portion 36, along with any optional cylindrical lower portion 38 that might be present, with the lower part of the drill bit 27 protruding from the bottom surface 39. When so modified, the device can be used as a guide pin for X-ray observation of the pilot hole position relative to concealed features of the patient's jaw. Additionally, the tapered portion 36 at the top of the modified device simulates a tooth in the position to be occupied by a crown at the end of the complete implant procedure should the existing pilot hole be used without modification. This enables the dentist to evaluate the hole in terms of alignment of the future crown with the patient's existing teeth. The purpose of shortening the top portion of the drill bit is to enable the patient to hold the X-ray film in place by closing his mouth. This arrangement will work with or without the presence of optional cylindrical lower portion 38. While either the setscrew option, the O-ring option, or the fixed option can be used, either of the first two will permit adjustment of the length of the drill bit extending below the drill bit mount device, thus enabling the drill bit tip to reach the bottom of the pilot hole during X-ray evaluation while maintaining the mount device at a proper height with respect to the existing teeth.

FIG. 20 shows a further arrangement with the cylindrical lower portion 38 of the drill bit mount device 20 formed with a cutting surface 30, formed on the lower portion, and positioned to facilitate cutting and leveling the surface of the alveolar ridge and any tissue between the ridge and the cutting surface. This enables the dentist further to prepare the implant site prior to implant installation. Among the embodiments, a preferred choice for employment of the cutting surface is the drill bit mount device formed integral with the drill bit as shown in FIG. 8, wherein the drill bit is not adjustable with respect to the drill bit mount device. This reduces the likelihood of slippage of the drill bit mount device on the drill bit shaft during use of the cutting surface.

Realizing that the primary purpose of the cylindrical lower portion 38 (FIG. 6) of the invention is that of providing a means for the dentist to visually see whether or not there is suitable space for the implant MP (FIG. 17), the invention recognizes that advantages would arise by separation of lower and upper portions of the device 20. Therefore, a modified substantially frustum-shaped device 20′ is shown in FIG. 18 in which the optional cylindrical lower portion 38 has not been installed on the tapered portion 36.

FIG. 21 illustrates an arrangement wherein the cylindrical lower portion 38′ of the device is attached to a rod 24′, thereby providing a measuring tool for visually measuring the availability of adequate space for installing a selected implant of similar diameter to that of the cylindrical lower portion 38′.

FIG. 22 illustrates another arrangement wherein the device of FIG. 21 is used in assembly with the device 20′ of FIG. 18. The substantially frustum-shaped upper tapered portion of the invention, similar in shape but smaller in size than the proposed crown, can be slipped over the rod 24′, as in FIG. 22, to provide a measuring tool that will also show the relationship between the crown and the existing teeth.

Having described the many arrangements in which components of the drill mount device of the invention can be arranged, various embodiments of the invention can thus be recognized and categorized in various ways. A first embodiment could be described as being a drill mount device comprising only the upper portion 36 of the device 20 as shown in FIG. 5; a second embodiment could be considered as a drill mount device comprising the upper portion 36 and lower portion 38 made as an integral structure as in FIG. 5; a third embodiment could be considered as a drill mount device comprising the upper portion 36′″, lower portion 38′″ and drill 24′″ formed as an integral structure 20′″ as in FIG. 8; and a fourth embodiment considered in one assembly as comprising a separately formed lower portion 38′ secured to a rod member 24′ and in another cooperative assembly as comprising a separately formed upper portion 36 also mounted on rod member 24′ as in FIGS. 21 and 22. it is from these four embodiments as well as other embodiments that might be recognized that the various described and other arrangements evolve all to the advantage of both the dental surgeon and the patient.

What is claimed is:

1. A dental drill assembly adapted for forming an implant pilot hole of predetermined depth and diameter comprising:
(a) a drill mount formed as an integral body and including:
(i) an upper portion having in appearance that of an inverted substantially frustum-shape extending downwardly from a top surface;
(ii) a lower portion shaped as a cylinder of substantially uniform diameter extending upwardly from a flat bottom surface; and
(iii) wherein the diameter of said lower portion is substantially the same as the diameter of an implant proposed for being installed; and
(b) a drill bit axially aligned with the central vertical axis of said mount, operatively associated with and adapted for being rotated in unison with said mount for forming an initial implant pilot hole to guide forming a larger concentric hole suited for receiving a cylindrical-shaped implant of substantially the same diameter as that of said drill mount lower portion.

2. The dental drill assembly of claim 1 wherein the lower portion has a lower surface formed as a cutting surface.

3. A dental drill assembly as claimed in claim 1 including top-surface grooves formed in said top surface and side-surface grooves formed in side surfaces of said upper portion.

4. A dental drill assembly as claimed in claim 3 including a visible mark formed on the periphery of said top surface and observable as forming a circle during rotation of said drill mount and drill bit, said circle providing a reference for determining correct positioning of said drill bit.

5. A dental drill assembly as claimed in claim 1 including a visible mark formed on the periphery of said top surface and observable as forming a circle during rotation of said drill mount and drill bit, said circle appearing to the eye when said drill bit is properly located as being in a plane aligned with the plane in which the top surfaces of the existing teeth are located.

6. A dental drill assembly as claimed in claim 1 wherein said upper portion comprises a major portion and said lower portion comprises a minor portion of said assembly.

7. A dental drill assembly as claimed in claim 1 wherein said drill mount and drill bit are formed as an integral body.

8. A dental drill assembly as claimed in claim 1 wherein said mount includes a centrally located vertical hole for receiving said drill bit and means for maintaining the position of said mount on said drill bit.

9. A dental drill assembly as claimed in claim 8 wherein said means for maintaining the position of said mount comprises a setscrew.

10. A dental drill assembly as claimed in claim 1 wherein said mount includes a centrally located vertical hole for receiving said drill bit and within said hole one or more horizontally positioned O-rings adapted to grasp and adjustably position said drill bit.

11. A dental drill assembly as claimed in claim 8 and including a visible mark formed on the periphery of said top surface and observable as forming a circle useful for reference during rotation of said drill mount and drill bit.

12. A method for forming a hole suited for receiving a substantially cylindrically-shaped implant whose diameter is sized to fit said hole, comprising:
(a) forming a drill mount as an integral body and including:
(i) an upper portion having in appearance that of an inverted substantially frustum-shape extending downwardly from a top surface; and
(ii) a lower portion shaped as a cylinder of uniform diameter extending upwardly from a bottom surface located perpendicular to the central vertical axis of said cylinder; and
(b) operatively associating with said drill mount a drill bit axially aligned with the central vertical axis of said mount and adapted for being rotated in unison with said mount for forming a pilot hole suited for drilling one or more larger holes for receiving a substantially cylindrical-shaped implant of substantially the same diameter as that of said drill mount lower portion.

13. The method of claim 12 including the step of providing a visible mark on the periphery of said top surface and observing said mark during rotation of said drill mount and drill bit.

14. The method of claim 12 including the step, prior to forming said pilot hole, of comparing for compatibility the diameter of said lower portion with the dimensions of the site available in which to form said hole.

15. The method of claim 14 including the steps of forming a visible mark on the periphery of said top surface and observing during forming of said pilot hole the mark and its location as an indication of correct positioning of said drill bit.

16. A dental drill assembly adapted for forming an implant pilot hole of predetermined depth and diameter comprising:
(a) a drill mount formed as an integral body having in appearance that of an inverted, substantially frustum-shape extending downwardly from a top surface whose top diameter is larger than its bottom diameter, and wherein said bottom diameter is substantially the same as the diameter of an implant proposed for being installed; and
(b) a drill bit axially aligned with the central vertical axis of said mount, operatively associated with and adapted for being rotated in unison with said mount for forming a pilot hole prior to drilling one or more larger holes for receiving a cylindrical-shaped implant of substantially the same diameter as that of the bottom of said drill mount.

17. A dental drill assembly adapted for forming an implant pilot hole of predetermined depth and diameter comprising:
(a) a drill mount including:
(i) a first portion positionable to serve as an upper portion and having in appearance that of an inverted substantially frustum-shape extending downwardly from a top surface; and
(ii) a second portion positionable to serve as a lower portion and shaped as a cylinder of substantially uniform diameter extending upwardly from a bottom surface perpendicular to a central vertical axis of said second portion; and
(b) a drill bit axially aligned with the central vertical axis of said first and second portions of said mount, operatively associated with and adapted for being rotated in unison with said second portion of said mount for forming an implant pilot hole to guide forming a larger concentric hole suited for receiving a cylindrical-shaped implant of substantially the same diameter as that of said drill mount lower portion.

18. A dental drill assembly as claimed in claim 17 wherein said first and second portions are formed as a single integral structure.

19. A dental drill assembly as claimed in claim 17 wherein said first and second portions are formed as separate parts of said mount.

20. A dental drill assembly as claimed in claim 17 wherein said first and second portions together with said drill are formed as a single integral structure.

21. Dental apparatus for forming a dental implant pilot hole of predetermined depth and diameter comprising a drill bit mount device having in appearance that of an inverted substantially frustum-shape extending downwardly from a top surface whose top diameter is larger than its bottom diameter, and wherein said bottom diameter is substantially the same as the diameter of an implant proposed for being installed in a patient's mouth.

22. The dental apparatus of claim 21 wherein said bottom diameter is at least 2 mm smaller than said top diameter and whose height is less than 2 cm.

23. The dental apparatus of claim 21 further comprising:
(a) at least one top-surface groove formed in said top surface;
(b) means for accommodating vertically a drill bit in a central location of said drill bit mount device; and
(c) means for maintaining the position of said mount on said drill bit.
